(19) United States
(12) Patent Application Publication
(10) Pub. No.: US 2025/0322529 A1
(43) Pub. Date: Oct. 16, 2025

(54) Video Event Segmentation

(71) Applicant: Apple Inc., Cupertino, CA (US)

(72) Inventors: Zhihao Zhu, Santa Clara, CA (US); Daniel Ulbricht, Sunnyvale, CA (US); Eshan Verma, San Francisco, CA (US)

(21) Appl. No.: 19/059,550

(22) Filed: Feb. 21, 2025

Related U.S. Application Data
(60) Provisional application No. 63/562,226, filed on Mar. 6, 2024.
(60) Provisional application No. 63/700,534, filed on Sep. 27, 2024.

(51) Int. Cl. G06T 7/12; G06V 10/764

(52) U.S. Cl. CPC G06T 7/12; G06V 10/764

(57) ABSTRACT

Various implementations disclosed herein include devices, systems, and methods that perform a video event segmentation process to segment video events that include a living entity interacting with an object. For example, a process may obtain frames of a video depicting a living entity and objects within a three-dimensional (3D) environment. The process may further identify the objects depicted in the frames and identifying an event based on the living entity and the objects. The event may involve the living entity and a subset of the objects. The process may further identify the subset of the objects involved in the event and segment the living entity and the subset of the objects involved in the event in the frames. The segmenting process may include identifying portions of the frames corresponding to the living entity and the subset of the objects.

### CROSS-REFERENCE TO RELATED APPLICATIONS

This application claims the benefit of U.S. Provisional Application Ser. No. 63/562,226 filed Mar. 6, 2024, and U.S. Provisional Application Ser. No. 63/700,534 filed Sep. 27, 2024, each of which is incorporated by reference herein in its entirety.

### TECHNICAL FIELD

The present disclosure generally relates to systems, methods, and devices that perform a video event segmentation process for segmenting video events that include a living entity interacting with an object(s).

### BACKGROUND

Existing techniques for associating portions of video with user associations may be improved with respect to specificity and simplicity to provide accurate viewing results.

### SUMMARY

Various implementations disclosed herein include devices, systems, and methods that perform a video event segmentation process to segment video events from a video that includes a living entity, such as, inter alia, a person, an animal, etc. interacting with an object. For example, a video event may include a person eating at a table, a person watching TV, etc.

In some implementations, objects associated with or included within specified event types may be segmented within video image frames. For example, during a TV watching video event, a person watching TV may be identified within the video event and therefore, the person and the TV may be segmented from the video.

In some implementations, a deep learning process or model may be used to perform video event segmentation. For example, a deep learning process or model may include identifying candidate event instances associated with major objects in a video (e.g., a person, a TV, a TV stand, a couch, etc.) and grouping the identified major objects together based on the deep learning process. In some implementations, major objects may be identified based on, inter alia, objects being larger than a threshold size, only certain types of objects, etc.

In some implementations, a deterministic, rule-based approach may be used perform video event segmentation. For example, a video event segmentation process may rely on predefined rules regarding object detection, person identification, and interaction patterns. These rules may apply to detect specific events such as watching TV or eating at a table, and segment the related entities (e.g., the person, TV, table, etc.) within the video frames. Temporal and spatial constraints may be used to ensure consistent segmentation across video frames.

In some implementations, a process or model may be trained to recognize events using data sets such as videos associated with known events in which known important objects belonging to each event are labeled as ground truth information.

In some implementations, a process or model may be trained using a fixed taxonomy of objects such as, inter alia, certain types of objects, etc.

Some implementations may provide open vocabulary event segmentation comprising segmenting any type of object and/or subsequently using the segmented objects to identify any possible event type.

In some implementations, an electronic device has a processor (e.g., one or more processors) that executes instructions stored in a non-transitory computer-readable medium to perform a method. The method performs one or more steps or processes. In some implementations, the electronic device obtains one or more frames of a video. The one or more frames may depict a living entity and one or more objects within a three-dimensional (3D) environment. In some implementations, the electronic device identifies the one or more objects depicted in the one or more frames. In some implementations, the electronic device identifies an event based on the living entity and the one or more objects. The event may involve the living entity and a subset of the one or more objects. In some implementations, the electronic device identifies the subset of the one or more objects involved in the event. In some implementations, the electronic device segments the living entity and the subset of the one or more objects involved in the event in the one or more frames. The segmenting process may include identifying portions of the one or more frames corresponding to the living entity and the subset of the one or more objects.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRA WINGS

So that the present disclosure can be understood by those of ordinary skill in the art, a more detailed description may be had by reference to aspects of some illustrative implementations, some of which are shown in the accompanying drawings.

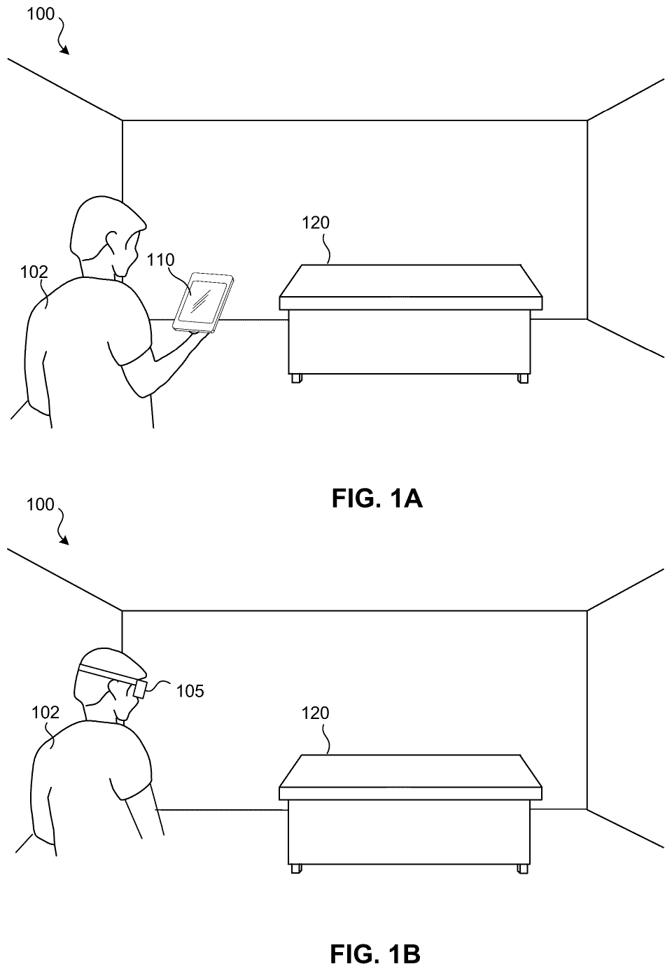

FIGS. 1A-B illustrate exemplary electronic devices operating in a physical environment in accordance with some implementations.

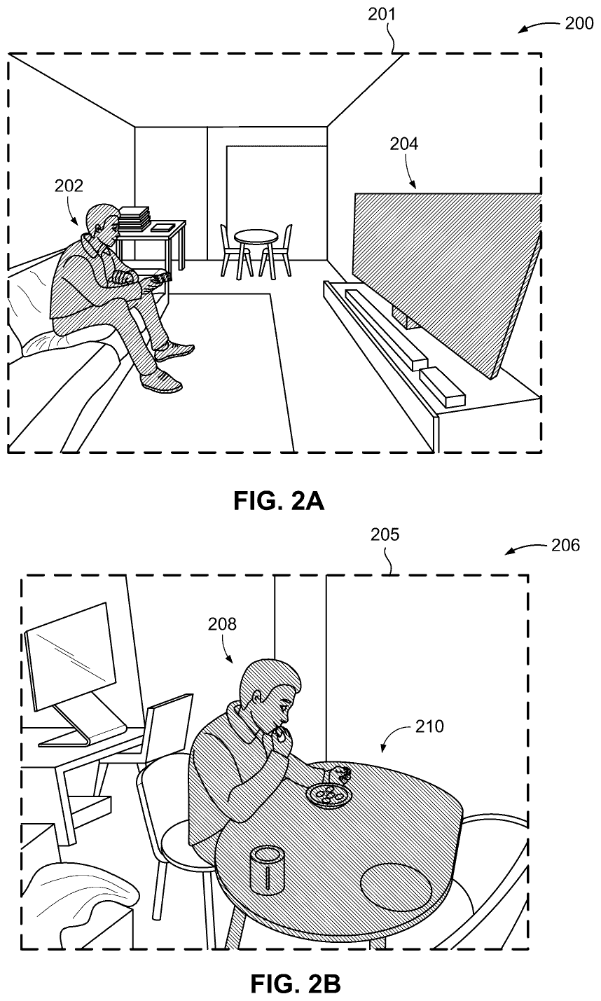

FIGS. 2A and 2B illustrate examples depicting a process for segmenting objects involved with specified events, in accordance with some implementations.

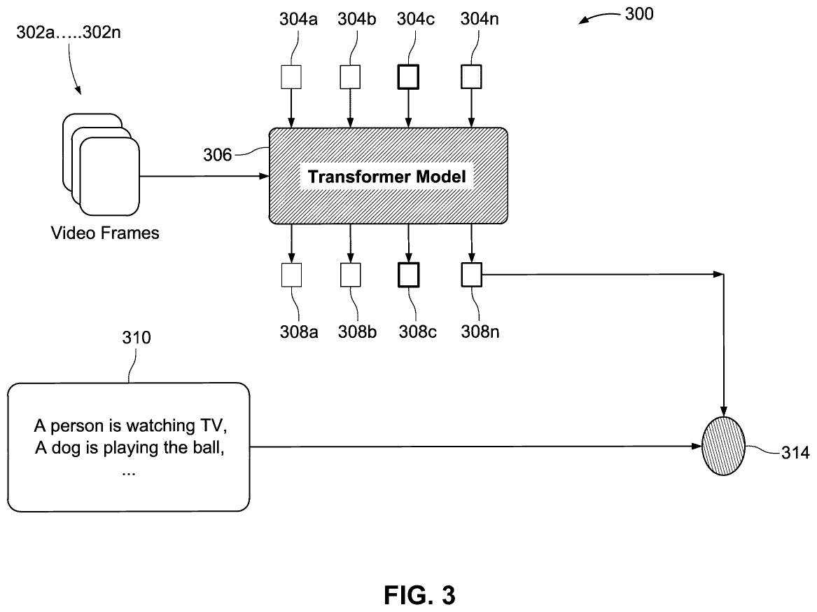

FIG. 3 illustrates a system configured to enable deep learning to perform video event segmentation, in accordance with some implementations.

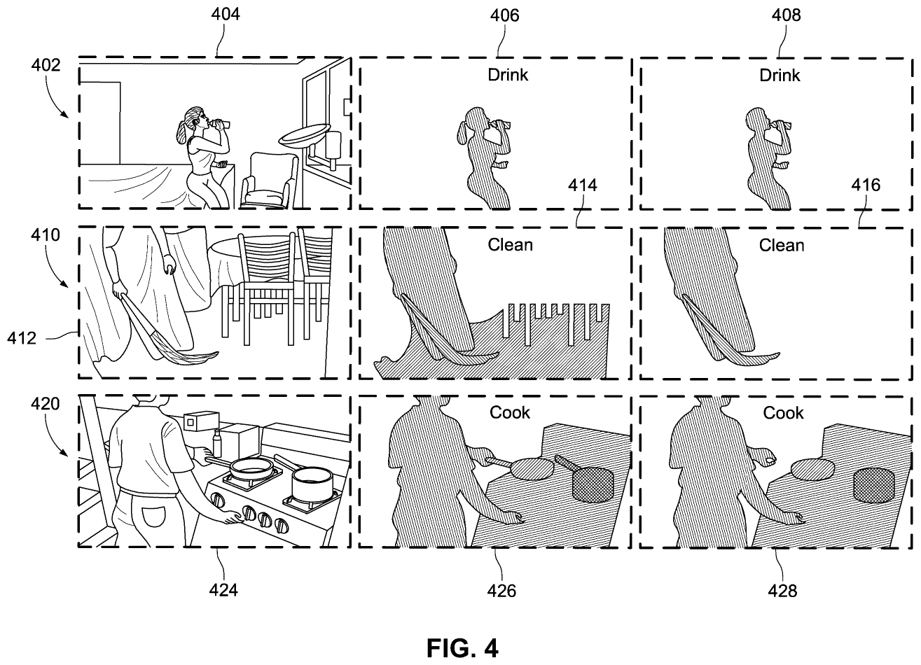

FIG. 4 illustrates differing video event segmentation processes associated with different videos, in accordance with some implementations.

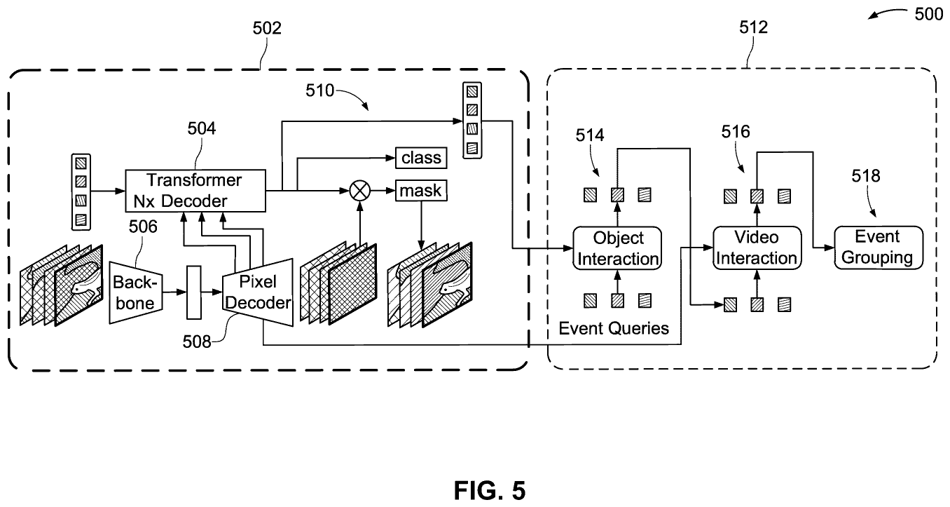

FIG. 5 illustrates transformer-based event segmentation architecture configured to provide video event grouping, in accordance with some implementations.

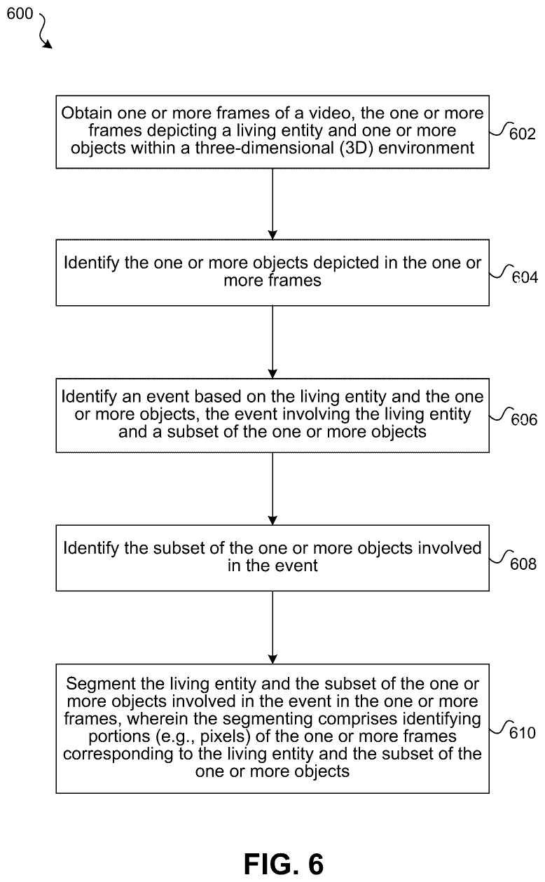

FIG. 6 is a flowchart representation of an exemplary method that performs a video event segmentation process to segment video events that include a living entity interacting with an object, in accordance with some implementations.

FIG. 8 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, one or more lighting sources having at least one polarizer, one or more microphones, depth sensors, or other sensors that can be used to capture information about and evaluate the physical environment 100 and the objects within it, as well as information (e.g., eye tracking information) about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

Various implementations disclosed herein include devices, systems, and methods that implement video event segmentation processes associated with segmenting video events that include a living entity interacting with an object.

In some implementations, one or more frames may be obtained from a video. The one or more frames may depict a living entity and object(s) within a 3D environment. For example, image or video representing a person or a pet and at least one object such as a TV, a table, a couch, etc. may be obtained from a video.

In some implementations, the object(s) and/or the living entity depicted in the one or more frames may be identified. Identifying the object(s) may include identifying only a major object(s) such as, inter alia, an object(s) that is larger than a threshold size, an object(s) of only a certain type, etc. In some implementations, identifying an object(s) may include use of a machine learning model that, for example, may have been trained using a fixed taxonomy of objects. Some implementations may enable an open vocabulary event segmentation process including segmenting any type of object(s) and/or using the object(s) to identify any possible event type.

In some implementations, an event may be identified based on the living entity interacting with the object(s). The event may include the living entity and a subset of the object(s).

In some implementations, one or more of the most significant events being depicted in the video may be identified based on, for example, importance criteria. In some implementations, identifying an object(s) and an event may occur in parallel and/or via a single machine learning model.

In some implementations, a subset of the object(s) involved in the event may be identified, for example, by grouping (important) objects to identify the subset.

In some implementations, the living entity and the subset of the object(s) involved in the event may be segmented in the one or more frames. In some implementations, segmenting the living entity and the subset of the object(s) may include identifying portions, such as pixels, of the one or more frames corresponding to the living entity and the subset of the object(s).

FIGS. 2A and 2B illustrate examples depicting a process for segmenting objects involved with specified events, in accordance with some implementations.

The examples illustrated in FIGS. 2A and 2B focus on a video event segmentation process configured to segment video events such as, for example, a person eating, a person watching TV, an animal running, etc. Some implementations may segment any objects included in a particular event. For example, with respect to an event comprising people eating apples, the people and the apples may be identified within the event and the segmentation process may include segmenting the people and the apple.

In some implementations, a close-set video instance segmentation process may be executed such that fixed-size taxonomies are used to segments individual video event instances.

In some implementations, an open-vocabulary video instance segmentation process may be executed using open-vocabulary objects (e.g., an apple, a cat, a dog etc.) and only individual objects are segmented.

In some implementations, open-vocabulary video event segmentation process may be executed such that an open-vocabulary event is detected (e.g., watching tv, petting a pet, etc.). In response, multiple objects belonging to a target event are grouped and segmented by an algorithm determining a reason specifying which objects belong to an event.

FIG. 2A illustrates a television (TV) watching event 200 detected in a video frame 201. In this instance, a person 202 and a TV 204 (i.e., an activity of watching TV) are segmented from the video frame.

FIG. 2B illustrates a dining event 206 detected in a video frame 205. In this instance, a person 208 and objects 210 (i.e., a table, a bowl, a cup, etc.) are segmented from the video frame.

Some implementations include using open vocabulary event segmentation to group objects that are involved in any type of event. Some implementations are configured to recognize every object involved in a given event (e.g., a single event) and segment the objects out of each frame of a video.

In some implementations, video event segmentation may be applied to alternative domains and areas, such as for example, during video conferencing, choosing to blur portions of a video other than a person and objects (i.e., an event) being interacted with. For example, not blurring a user and a cup being held by the user, not blurring a user and a tennis racquet and ball being interacted with, etc.

In some implementations, a deterministic, rule-based approach may be used perform video event segmentation. Accordingly, a video event segmentation process may rely on predefined rules regarding object detection, person identification, and interaction patterns. These rules may apply to detect specific events such as watching TV or eating at a table, and segment the related entities (e.g., the person, TV, table, etc.) within the video frames. Temporal and spatial constraints may be used to ensure consistent segmentation across video frames. For example, the presence of a person may be detected within a video frame and object detection algorithms or predefined scene context may be used to check for the presence of a TV in the frame. Likewise, a use may be detected as oriented towards the TV (e.g., body facing the TV within an acceptable angle range) and in response the person and the TV may be segmented from the video frame based on the rules. The rules may be subsequently applied across the video frames to ensure that the event persists for a reasonable duration (e.g., person must face the TV for at least 2 seconds).

Some implementations use a deep learning process to perform video event segmentation as further described with respect to FIG. 3, infra.

FIG. 3 illustrates a system 300 configured to a enable deep learning process to perform video event segmentation, in accordance with some implementations. System 300 comprises a transformer model 306 applying queries 304a . . . 304n to video frames 302a . . . 302n to represent an initial video event segment prediction. In response, transformer model 306 generates as an output, queries 308a . . . 308n representing actual video event segments. Subsequently, captions 310 describing video events may be applied to video event segments 314.

In some implementations, transformer model 306 may be configured to execute a deep learning process to perform video event segmentation via two stages as follows: A first stage accepts as input, proposals for a few video event segment candidate instances associated with any major object in an image or video. Subsequently, a second stage may identify a major event in the image or video and group, for example, the most important objects involved in the major event.

In some implementations, transformer model 306 may be trained to recognize video event segments using data sets such as, inter alia, videos associated with known events and known important objects belonging to each event thereby providing ground truth information for the training.

In some implementations, videos or video segments that include events over entire video may be segmented. In some implementations, an event localization process (e.g., identifying when in time an event starts and ends) may be performed prior to video event segmentation. The event localization process may include splitting a video into segments corresponding to different events. Likewise, a deep learning model may be configured to input videos in which one or more events occur for the entire duration of the input video (e.g., a video segment).

Some implementations identify multiple events in a single video (e.g., video segment). For example, this may include identifying a dining event and a TV watching event and associating each event with respective objects. For example, a dining event may be associated with a person and a plate of food and a TV watching event may be associated with person interacting with a TV.

Some implementations may utilize fixed taxonomies of objects in training such that the training is only exposed to limited sets of objects (e.g., certain types of objects) for event segmentation. Subsequently, whenever a network detects objects belonging to the fixed taxonomies, the objects may be segmented out regardless of whether contributing to an event or not and then a second step may be used to identify events based on those objects.

Some implementations may provide open vocabulary event segmentation that may include segmenting any type of object and/or then using those objects to identify any possible event type.

Some implementations may involve identifying events that are not predefined. For example, a training set may include many TV watching events. However, when implemented, if the user is via a video via an head mounted display (HMD), it may not have been exposed in the training set but system 300 may generalize. Therefore, given the label of a person and an HMD, the person and the HMD may be grouped in an event of watching an HMD even though the HMD watching event was not exposed in the training data.

Some implementations identify objects associated with an event based on training data. For example, system 300 may have learned to associate a person and a TV with a TV watching event without including a table that the TV is resting on. Therefore, how the training data is labelled may thus dictate how objects are grouped for particular activities and these groupings for training data may be manually or automatically generated.

Some implementations, determine both (a) one or more events (e.g., major events) occurring in a video and (b) which objects are involved with each of those events. The events and objects may be determined in parallel within a machine learning model.

In some implementations, events may be defined as activities involving specific entities (e.g., only humans, humans and animals, etc.). Likewise, large taxonomies may be used for training to describe events involved with specific objects. In some implementations, events may be identified by parsing video labels such as, for example, a person sitting on couch watching TV may be parsed into TV watching and sitting events. Associated concepts may be derived or learned from captions such as existing captioned video data sets.

Some implementations provide segmentations that identify locations of objects (associated with an event) in every frame of a video. Some implementations identify the locations of the objects (associated with an event) in only a subset of the frames (e.g., an initial frame, every 10th frame, etc.).

Some implementations define video events as activities in context. For example, objects in an environment may be connected to an entity carrying out an activity. Being able to recognize video events (e.g., in pixel-space) may be associated with applications of robotics, autonomous systems and long-range temporal video analysis. To achieve pixel-level video event recognition, various features may be utilized. First, some implementations may introduce a task of video event segmentation, which aims to classify, group and segment all the objects that belong to a same video event. Some implementations may classify a category of a video event. Second, to benchmark the task of video event segmentation, some implementations may involve a new event segmentation dataset that contains well-annotated event classifications and corresponding object grouping and segmentation. Some implementations may use an efficient DETR-style transformer architecture such as EventSeg along with an evaluation suite, to establish a baseline for accurate event segmentation performance.

Some implementations may utilize a first large-scale dataset (e.g., Charades-Event-Seg) for video event segmentation. The large-scale dataset may be built on top of two datasets: charades and action genome, where an action genome is an additional scene graph annotation on top of charades videos. Therefore, existing object annotations may be leveraged within Action Genome dataset, grouped objects under same events, and segmentation masks may be added on the objects. Additionally, an object tracking annotation may be added since it is missing in the Action Genome dataset. Additional details related to data annotation and statistics are described as follows:

Some implementations utilize a novel algorithm (e.g., EventSeg) comprising two major components: an object segmentation proposal module and an event grouping module. The object segmentation proposal module comprises a baseline on top of a SOTA video instance segmentation method: Mask2Former for videos. The object segmentation proposal module may be configured to model temporal dynamics among video frames and propose initial object segmentation masks. Subsequently, the proposed initial object segmentation masks and video features are input into the event grouping module to group all the objects belonging to the same events. Both modules may follow a similar design as DETR. Some implementations provide a baseline method that directly predicts all the pixel labels that belong to an event.

FIG. 4 illustrates different video event segmentation processes 402, 410, and 420 associated with different videos, in accordance with some implementations. For example, video event segmentation process 402 illustrates a sampled frame 404 (of a video), a ground-truth event segmentation annotation 406, and an event segmentation prediction 408 generated by a model such as transformer model 306 as illustrated in FIG. 3, supra. In some implementations, ground-truth event segmentation annotation 406 represents different instances involved in events being annotated with segmentation masks and marked with different colors for differentiation. Video event segmentation process 410 illustrates a sampled frame 412 (of a video), a ground-truth event segmentation annotation 414, and an event segmentation prediction 416 generated by a model such as transformer model 306 as illustrated in FIG. 3, supra. In some implementations, ground-truth event segmentation annotation 414 represents different instances involved in events being annotated with segmentation masks and marked with different colors for differentiation. Video event segmentation process 420 illustrates a sampled frame 424 (of a video), a ground-truth event segmentation annotation 426, and an event segmentation prediction 428 generated by a model such as transformer model 306 as illustrated in FIG. 3, supra. In some implementations, ground-truth event segmentation annotation 426 represents different instances involved in events being annotated with segmentation masks and marked with different colors for differentiation.

In some implementations, video event segmentation process is executed such that an event concept is recognized and all objects belonging to that event are segmented. Likewise, a large-scale dataset comprising, for example, 42 k segmentation masks and 28,922 event instances may be utilized to enable the video event segmentation process. In some implementations, video event segmentation may include a predefined event category label set Cₑ=1, . . . , K and a predefined object category label set Cₒ=1, . . . , F, where K, F are the number of the event categories, and object categories, respectively. Given a video Sequence with T frames, suppose there is a list of N objects indexed [1, 2, . . . , N] belonging to the category set Cₒ, and M events belonging to the category set Cₑ in the video. For each object i. let cⁱₒ∈Cₒ denote its category label, and let _{mpi . . . q} denote its binary segmentation masks across the video where p∈[1, T) and q∈(p, T] denote the starting and ending time frame. For each event j, let c^{j}ₑ∈Cₑ denotes the event label, and let gⱼ={indexⁱⱼ, . . . , index^{Mj}ⱼ} denote the list of objects belonging to the event j, where each element indexⁱⱼ corresponds to an object index among N objects. Mⱼ is the number of objects in event j. Suppose a video event segmentation algorithm produces H number of instances hypothesis, and T number of events hypothesis. For each object hypothesis, there needs to be a predicted category label, a confidence score, and a sequence of predicted binary masks, all of which are used for evaluating the instance segmentation performance. Additionally, for each event hypothesis, there needs to be a predicted event category label, and, a list of predicted object indices indicating which predicted objects belong to each event hypothesis. All of these will be used for evaluating the event segmentation performance as follows:

The aforementioned event segmentation task is configured to minimize a difference between a ground truth and a prediction. For example, an adequate video event segmentation model may be associated with a classification of a video event and may accurately identify, segment, and group all objects belonging to the events.

In some implementations, an event segmentation performance may be evaluated in two sub-parts: an evaluation of video instance segmentation performance and an evaluation of accuracy for event grouping and classification. For example, an evaluation of video instance segmentation performance may be used as evaluation metrics. Likewise, an event grouping and classification may use Hungarian matching to locate matches between predicted events and ground truth events and then use F1 scores to measure both the event classification and event grouping performance. Subsequently, the F1 scores may be combined into one by adding them together. Since these the AP and F1 metrics are different in their nature, both metrics may be used to evaluate the event segmentation from different perspectives.

In some implementations, video events may be decomposed into prototypical action-object units. For example, charades datasets may comprise rich event information and an action genome may be built on top of charades datasets to group objects involved in the same events and to capture their relations. Some implementations may target different tasks such as, for example, an action genome may be configured to focus on object detection and relation prediction while object segmentation and grouping is targeted such that existing annotations from an action genome may be used for building an event segmentation dataset.

In some implementations, an action genome may be configured to add a spatial temporal scene graph annotation on top of charades datasets such that given an action, it uniformly samples 5 frames during the action period, and annotates a scene graph on each selected frame. Likewise, nodes in the scene graph may represent all objects involved in the events and edges in the scene graph may represent the object relations. Therefore, action and object information may be used to construct an event segmentation dataset with modifications.

In some implementations, an annotation pipeline may be implemented to enable a pre-modification task to an action genome to execute an event segmentation task. In some implementations, it may be observed that not all the objects in an annotated scene graph contribute to the corresponding events. For example, with respect to an event associated with person looking outside a window, a sub-graph between the person, a table and a chair may not contribute to an event of looking outside the window. Therefore, over-grouping objects in an event may be detrimental for training an accurate event grouping model so object annotations may be manually filtered such that only the most relevant objects involved for each event are retained. In some implementations, video event segmentation may first require video instance segmentation where objects/instances in each frame must be tracked but if object tracking information is missing from an action genome annotation, the objects/instances in each frame may be added to an event segmentation dataset. Likewise, a multi-label video action dataset may be used with respect to multiple actions happening in a same video overlapping in time. Subsequently, the video may be manually trimmed such that each trimmed video may contain multiple actions, but each action may populate at least 90% of a video length so that temporal localization issues may be mitigated. In some implementations, a set of actions may be defined such that there is little temporal dynamics such as a person sitting on a chair. This type of action may be retained in a video. Likewise, verb classes provided by a charades dataset may be used as event taxonomies, since original charades action classes may reveal information associated with an object. Charades may additionally provide mapping from action classes to verb classes.

FIG. 5 illustrates transformer-based event segmentation architecture 500 configured to provide video event grouping, in accordance with some implementations. Transformer-based event segmentation architecture (EventSeg) 500 may include the following components: a video instance proposal module 502 and an event grouping module 512.

Video instance proposal module 502 may include a transformer-decoder 504, a backbone 506, a pixel decoder 508, and a mask module 510. Video instance proposal module 502 may be configured to segment, track, and classify object queries.

Event grouping module 512 may include an object interaction module 514, a video interaction module 516, and an event grouping module 518. Event grouping module 512 may be configured to group objects with respect to similar events and classify event labels.

In some implementations, video instance proposal module 502 accepts as input, videos 505 to generate as an output, a fixed number of instance proposals 507. Subsequently, event queries are cross-referenced with instance proposals 507 and video features to generate event grouping and classification.

In some implementations, a video instance segmentation process is configured to segment a video in an end-to-end manner such that each instance query is used for segmenting both spatially and temporally. In some implementations, line decoupled video instance proposal (VIS) methods may be utilized such that frame-level instance segmentation processes are performed and a tracking module may be added to associate instances across frames. In some implementations, mask refinement may be added (via mask module 510) after tracking to improve VIS performance. While decoupled approaches generally enable adequate performance with respect to video instance segmentation, an end-to-end approach may be used as a baseline video instance proposal module with respect to simplicity and efficiency.

In some implementations, a baseline approach may follow Mask2Former for videos with a few modifications to improve VIS performance. For example, given a video sequence I=[I₁, . . . , I_{T}] with T frames, each frame Ii∈R^{W×H×3} is individually input into a backbone encoder and pixel decoder such that frame features for one video are stacked in a transformer decoder to decode object queries into masks and labels. Therefore, temporal modeling may occur only in a late stage of instance segmentation, while many temporal dynamics are lost during an early stage. To mitigate this issue, model temporal dynamics may be applied throughout an instance segmentation pipeline such that an image backbone may be replaced with a transformer video backbone. Subsequently, the entire video may be fed into a backbone to extract video features for improved temporal modeling and then input into a pixel-decoder and a transformer decoder.

In some implementations, video instance proposal module 502 may be configured to produce a number of instances and multi-scale video features for input in for event grouping and classification. For example, a fixed number of M learnt event queries may be initialized such that each event query is responsible for recognizing a video event and grouping objects under that event. Subsequently, event queries are configured to interact with video features and object proposals to capture both object- and video-level context. Likewise, a relevance between event queries and object queries may be measured and object queries may be assigned to events based on their relevance score.

In some implementations, event grouping module 518 may comprise three layer types: an object context interaction layer, a video context interaction layer, and a relevance score calculation layer. The object context interaction layer and video context interaction layer may use multi-scale cross attention processes and event queries may be first projected with a projection matrix and subsequently input as queries for the attention processes. Additionally, following DETR, learned positional embeddings may be added for differentiating different event queries. The object context interaction layer may enable object queries from transformer-decoder 504 to be first mapped with a projection matrix and then used as keys and values in cross attention processes. Similar to object context interaction layer, video context interaction layer uses cross attention processes by using updated event queries from the object context interaction layer as query inputs. The keys and values for the video context interaction layer comprise video features from pixel decoder 508. Multiple object context interaction and video context interaction layers may be stacked for event queries to capture context. In some implementations, 3 layers of object context interactions and video context interactions may be used.

In some implementations (when event queries are updated with object and video information), event-object relevance may be measured (within a relevance score calculation layer) by first projecting event queries and object queries with two learned project matrices (e.g., in a same space) and then calculating a cosine distance between them. Since each event may involve a variable number of objects, a soft assignment process may be implemented by assigning objects to an event if an associated correlation score exceeds a pre-defined threshold of, for example, 0.5. Therefore, an object may be assigned to any events or no events such that an event may include any objects or no objects. Event queries may additionally be used for classifying an event by feeding the event into a classification head comprising a multi-layer-perceptron, followed by a softmax layer.

In some implementations, event queries may be enabled to represent a void event with respect to an event being assigned 0 objects or 2 objects such that an event may be classified into a negative event class. In some implementations (during an initial training), many events may be detected as being void events since they may not contain any objects and as the training progresses, prediction results may converge to the GT.

In some implementations, a training and loss process may be executed with respect to a two-stage pipeline enabling two instances. A first instance may comprise an object segmentation loss comprising a similar training loss with respect to Mask2Former training for set predictions. For example, binary cross-entropy loss and object score loss may be used such that a mask loss comprises a sum of dice loss and binary focal loss. A second instance may be associated with an event grouping and classification loss. Similar to the object segmentation loss, a Hungarian matching process may be implemented to match predicted events with ground-truth events by taking two factors into account: (1) an event label and (2) event grouping.

FIG. 6 is a flowchart representation of an exemplary method 600 that performs a video event segmentation process to segment video events that include a living entity interacting with an object, in accordance with some implementations. In some implementations, the method 600 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains one or more frames of a video depicting a living entity and one or more objects within a three-dimensional (3D) environment. For example, a person 202, a TV 204, a couch, etc. as described with respect to FIG. 2A.

At block 604, the method 600 identifies the one or more objects depicted in the one or more frames. For example, a TV 204 as described with respect to FIG. 2A.

In some implementations, identifying the objects may include using a machine learning model trained using a fixed taxonomy of objects as described with respect to FIG. 3.

In some implementations, identifying the objects may include enabling an open vocabulary event segmentation process comprising segmenting at least one of the one or more objects as described with respect to FIGS. 2A and 2B.

At block 606, the method 600 identifies an event based on the living entity and the one or more objects. The event may involve the living entity and a subset of the one or more objects. For example, an event comprising a person 202 engaging in an activity of watching a TV 204 as described with respect to FIG. 2A.5. The method of any of claims 1-4, wherein said identifying the event comprises identifying one or more significant events associated with the one or more objects being depicted within the video.

In some implementations, identifying the one or more significant events may be based on an event importance criteria as described with respect to FIG. 3.

In some implementations, identifying the one or more objects and identifying the event may occur in parallel.

In some implementations, identifying the one or more objects and identifying the event occur via execution of a single machine learning model such as transformer-decoder 504 as described with respect to FIG. 5.

At block 608, the method 600 identifies the subset of the one or more objects involved in the event. For example, a subset of objects 210 (i.e., a table, a bowl, a cup, etc.) may be identified as described with respect to FIG. 2B.

In some implementations, identifying the subset of the one or more objects involved in the event may include grouping the one or more objects to identify the subset as described with respect to FIG. 3.

In some implementations, the subset of the one or more objects involved in the event may include the most important objects involved in the event.

At block 610, the method 600 segments the living entity and the subset of the one or more objects involved in the event in the one or more frames as illustrated in FIGS. 2A and 2B. The segmenting process may include identifying portions (e.g., pixels) of the one or more frames corresponding to the living entity and the subset of the one or more objects. For example, person 208 and objects 210 as illustrated in FIG. 2B.

In some implementations, identifying an event type may be based on the segmented at least one of the one or more objects.

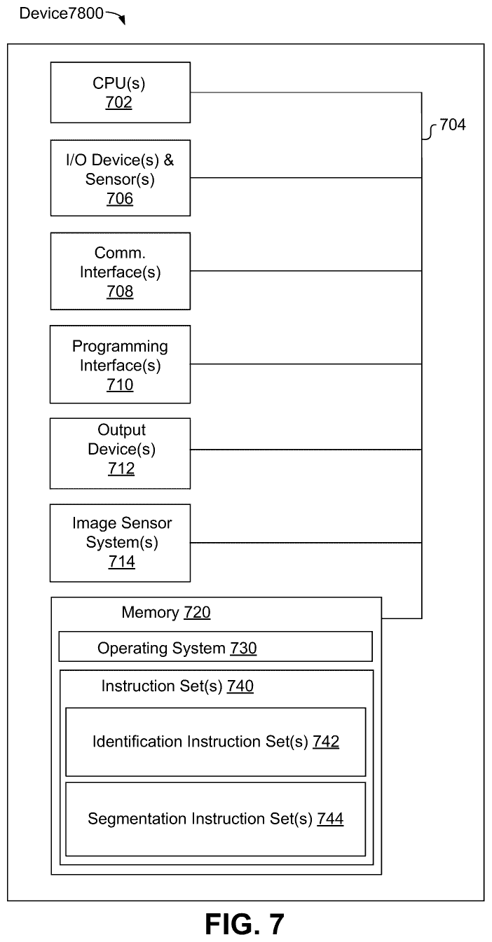

FIG. 7 is a block diagram of an example device 700. Device 700 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 710, output devices (e.g., one or more displays) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 712 are configured to present a view of a physical environment, a graphical environment, an extended reality environment, etc. to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 100. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes an identification instruction set 742 and a segmentation instruction set 744. The instruction set(s) 740 may be embodied as a single software executable or multiple software executables.

The identification instruction set 742 is configured with instructions executable by a processor to identify objects depicted in frames of a video, an event based on a living entity interacting with the objects, and a subset of the objects involved in the event.

The segmentation instruction set 744 is configured with instructions executable by a processor to segment the living entity and the subset of objects involved in the event from the frames of the video.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor:
obtaining one or more frames of a video, the one or more frames depicting a living entity and one or more objects within a three-dimensional (3D) environment;
identifying the one or more objects depicted in the one or more frames;
identifying an event based on the living entity and the one or more objects, the event involving the living entity and a subset of the one or more objects;
identifying the subset of the one or more objects involved in the event; and
segmenting the living entity and the subset of the one or more objects involved in the event in the one or more frames, wherein the segmenting comprises identifying portions (e.g., pixels) of the one or more frames corresponding to the living entity and the subset of the one or more objects.

2. The method of claim 1, wherein said identifying the one or more objects comprises using a machine learning model trained using a fixed taxonomy of objects.

3. The method of claim 1, wherein said identifying the one or more objects comprises enabling an open vocabulary event segmentation process comprising segmenting at least one of the one or more objects.

4. The method of claim 1, further comprising:
identifying an event type based on the segmented at least one of the one or more objects.

5. The method of claim 1, wherein said identifying the event comprises identifying one or more significant events associated with the one or more objects being depicted within the video.

6. The method of claim 5, wherein said identifying the one or more significant events is based on an event importance criteria.

7. The method of claim 1, wherein said identifying the one or more objects and said identifying the event occur in parallel.

8. The method of claim 1, wherein said identifying the one or more objects and said identifying the event occur via execution of a single machine learning model.

9. The method of claim 1, wherein said identifying the subset of the one or more objects involved in the event comprises grouping the one or more objects to identify the subset.

10. The method of claim 9, wherein the subset of the one or more objects involved in the event comprise the most important objects involved in the event.

11. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining one or more frames of a video, the one or more frames depicting a living entity and one or more objects within a three-dimensional (3D) environment;
identifying the one or more objects depicted in the one or more frames;
identifying an event based on the living entity and the one or more objects, the event involving the living entity and a subset of the one or more objects;
identifying the subset of the one or more objects involved in the event; and
segmenting the living entity and the subset of the one or more objects involved in the event in the one or more frames, wherein the segmenting comprises identifying portions (e.g., pixels) of the one or more frames corresponding to the living entity and the subset of the one or more objects.

12. The electronic device of claim 11, wherein said identifying the one or more objects comprises using a machine learning model trained using a fixed taxonomy of objects.

13. The electronic device of claim 11, wherein said identifying the one or more objects comprises enabling an open vocabulary event segmentation process comprising segmenting at least one of the one or more objects.

14. The electronic device of claim 11, further comprising:
identifying an event type based on the segmented at least one of the one or more objects.

15. The electronic device of claim 11, wherein said identifying the event comprises identifying one or more significant events associated with the one or more objects being depicted within the video.

16. The electronic device of claim 15, wherein said identifying the one or more significant events is based on an event importance criteria.

17. The electronic device claim 11, wherein said identifying the one or more objects and said identifying the event occur in parallel.

18. The electronic device of claim 11, wherein said identifying the one or more objects and said identifying the event occur via execution of a single machine learning model.

19. The electronic device of claim 11, wherein said identifying the subset of the one or more objects involved in the event comprises grouping the one or more objects to identify the subset.

20. A non-transitory computer-readable storage medium, storing program instructions executable by one or more processors to perform operations comprising:
obtaining one or more frames of a video, the one or more frames depicting a living entity and one or more objects within a three-dimensional (3D) environment;
identifying the one or more objects depicted in the one or more frames;
identifying an event based on the living entity and the one or more objects, the event involving the living entity and a subset of the one or more objects;
identifying the subset of the one or more objects involved in the event; and
segmenting the living entity and the subset of the one or more objects involved in the event in the one or more frames, wherein the segmenting comprises identifying portions (e.g., pixels) of the one or more frames corresponding to the living entity and the subset of the one or more objects.
